(19) United States
(12) Patent Application Publication
(10) Pub. No.: US 2008/0223882 A1
(43) Pub. Date: Sep. 18, 2008

(54) EASY PASS PITCHER

(76) Inventor: Charles P. Maxwell, Gurnee, IL (US)

Correspondence Address: PEARNE & GORDON LLP, 1801 EAST 9TH STREET, SUITE 1200, CLEVELAND, OH, 44114-3108, US

(21) Appl. No.: 11/685,874

(22) Filed: Mar. 14, 2007

(51) Int. Cl. A47J 45/06; A47G 19/14

(52) U.S. Cl. 222/466; 222/465.1

(57) ABSTRACT

An open top pitcher provided with a full grip standoff handle on a side opposite a projecting pouring spout and a positive finger grip structure beneath the pouring spout whereby the pitcher lends itself to be easily passed hand to hand from one person to another. The geometry of the pitcher can include auxiliary speed pouring spouts and allows the pitcher to be economically injection molded.

### BACKGROUND OF THE INVENTION

The invention relates to beverage containers/dispensers and, more particularly, to hand-held pitchers used to dispense potable liquids into smaller utensils.

### PRIOR ART

Probably longer than recorded history would reveal, mankind has fashioned utensils for provisionally holding potable liquids from the time they were collected, harvested, concocted, and/or modified, until they were consumed. One such type of utensil has evolved into what are called pitchers that are of a size that one person can carry from room to room, table to table, and place on a table or like serving bar. These containers, characterized by an open top, have been made in nearly infinite sizes and shapes over what must be several millennium. In modern times, pitchers have commonly been molded of plastic material, typically thermoplastic material and, less frequently, thermosetting plastic material. Besides efforts at styling an attractive shape, designers have often sought pitchers with shapes and features that facilitate use of the pitcher by a server who transports it from where it is filled to where it is dispensed from and by those who dispense its contents by pouring from it. Seemingly, little or no recognition has been given by product designers and manufacturers to the problem of providing a pitcher of a size adequate to serve a group of people and at the same time be configured to be conveniently hand-passed between a server and member of the group as well as between such members.

### SUMMARY OF THE INVENTION

The invention provides an open top, multi-serving beverage pitcher that can be passed hand to hand from one person to another with exceptional ease, certainty, and versatility. Likewise, the pitcher can be held and/or transported more readily than conventional pitchers by people with limited hand strength and/or dexterity by reason of youth, age, disability, or infirmity.

The invention utilizes two kinds of hand holds, each on opposite sides of the pitcher to achieve its high level versatility and convenience to the user.

Festivities, including parties, weddings, picnics, and like activities at taverns, halls, restaurants, parks, and so forth, are ordinarily attended by numerous participants and typically involve the consumption of liquid beverages in significant quantities. Where the participants are congregated in close quarters, it may be difficult, awkward, and time consuming for a server to deliver a pitcher full of beverage and formally place it on a table. The participants or party goers frequently are standing shoulder-to-shoulder or, frequently, even leaning over those sitting at a table. In these circumstances, it may be impractical for a server to reach a clear spot at a table on which to place a pitcher full of beverage. It, therefore, can be easier, more convenient, and/or quicker to just pass the pitcher into the hand or hands of a participant. Moreover, a full pitcher may be passed from participant to participant to reach its intended destination. Still further, as the beverage is being distributed into successive glasses, cups, or like containers the pitcher will often be moved from place to place among those consuming the beverage. This movement of the pitcher will ordinarily be accomplished by hand passing the pitcher from hand to hand among the participants, even if the weight of the pitcher is supported by sliding it across a table or bar surface. The pitcher of the invention greatly facilitates such hand transfer from one person to another.

There are many circumstances where a full pitcher can be difficult for people of limited physical strength or dexterity to carry the pitcher with one hand. Children and the elderly, those with infirmities such arthritis, in particular, can be too weak to support a full pitcher in one hand, but are capable of carrying a pitcher of the invention with two hands since it provides a secure grip for both hands.

The disclosed pitcher includes a projecting narrowed spout in a conventional location opposite a standoff handle. The standoff handle, which can be reliably and securely gripped by fully encircling it with the fingers, including the thumb, of a person's hand, is complemented, according to the invention, with specially formed finger grips that straddle a zone below the projecting spout. Preferably, the pitcher includes auxiliary, less prominently projecting spouts symmetrically disposed on either side of the projecting spout.

The relative geometry and arrangement of the handle and grips yields a high degree of versatility in the manner in which the pitcher can be used to dispense its contents as well as the manner in which it can be supported by one person and simultaneously grasped by and/or handed off to another.

### BRIEF DESCRIPTION OF THE DRAWINGS

FIG. 1 is a perspective view of one embodiment of the pitcher of the invention;

FIG. 2 is a side elevational view of the pitcher of FIG. 1;

FIG. 3 is a top or plan view of the pitcher of FIG. 1;

FIG. 4 is a front elevational view of the pitcher of FIG. 1;

FIG. 5 is a rear elevational view of the pitcher of FIG. 1;

FIG. 6 is a bottom view of the pitcher of FIG. 1;

FIG. 7 is a cross-sectional view of the pitcher taken in the plane 7-7 indicated in FIG. 4; and

FIGS. 8A-8D are different representations of typical manners by which the pitcher of the present invention can be passed from hand to hand and from person to person.

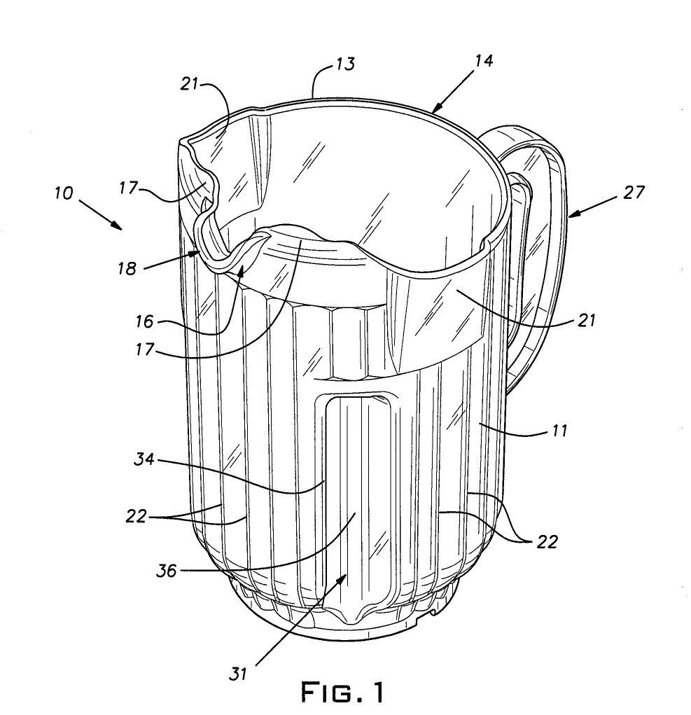

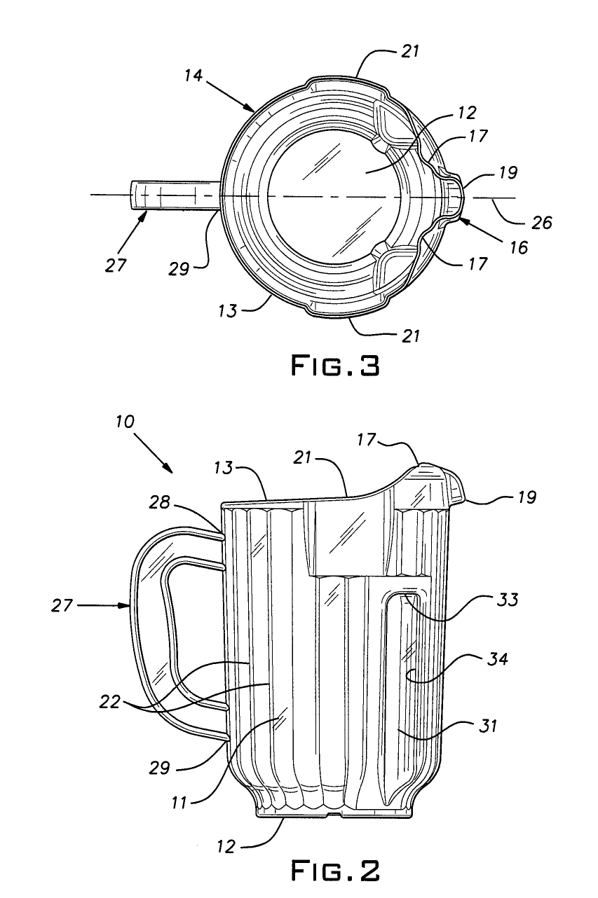

### DESCRIPTION OF THE PREFERRED EMBODIMENT

There is shown in the figures a pitcher 10 constructed in accordance with the invention. Preferably, the pitcher 10 is injection molded of a transparent thermoplastic material such as polycarbonate or SAN, but other forms of the pitcher can be translucent or opaque and/or blow molded and/or be made of a suitable thermosetting plastic material or of glass or metal, where desired or necessary.

The pitcher is sized to nominally contain at least 60 fluid ounces (US Customary System) i.e. about one-half gallon, so that it can be used when filled with a potable liquid such as water or a beverage to dispense the same to fill a plurality of drink glasses, cups, or the like. The term beverage, as it will be used herein, will include water or other potable liquid and will include potable iced liquids, i.e. liquids carrying chips, cubes, or other forms of ice.

The pitcher or vessel 10 is formed of sidewall areas 11 and a bottom end wall 12 normally molded in one piece, i.e. integral with one another. The sidewall areas 11 extend generally upwardly from the bottom end wall 12 so that, in the illustrated case, the interior volume of the pitcher is bounded by the end wall 12 and sidewall areas 11. This interior volume or space is generally circular when viewed in imaginary horizontal planes such as in FIG. 7, and preferably nearly cylindrical in configuration.

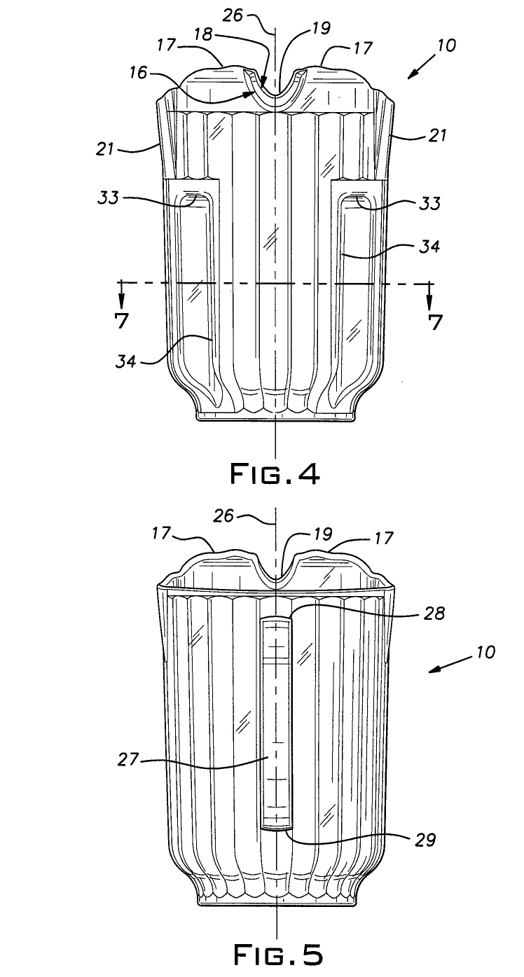

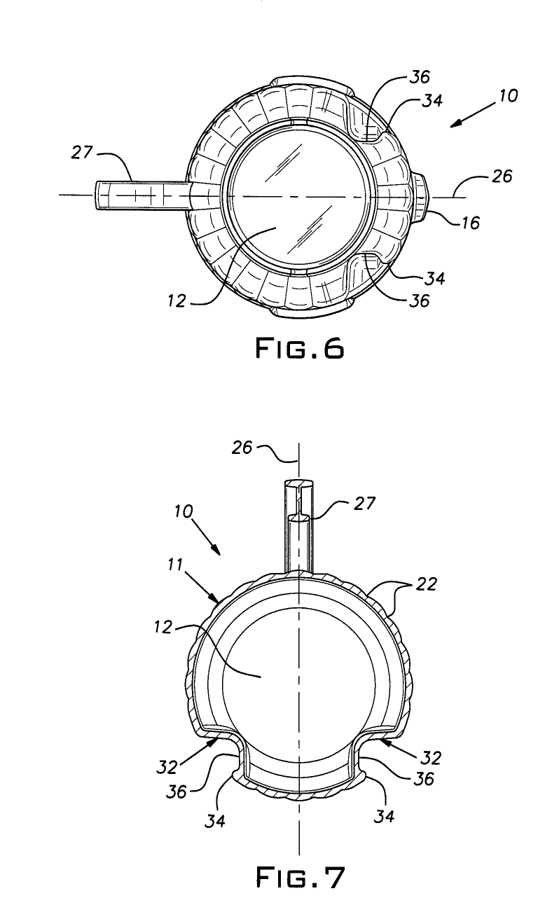

An upper edge 13 of the sidewall areas borders, in the manner of a lip, a wide mouth 14 for admitting or discharging beverage to and from the interior of the pitcher 10. In one region, the sidewall area 11 is formed into a spout 16 that projects outwardly from surrounding parts of the sidewall area. On opposite sides of the spout 16, proximal parts 17 of the sidewall areas 11 are somewhat higher than distal parts of the sidewall area. These higher parts 17 are turned inward somewhat towards the space just above the interior of the pitcher. A spout discharge 18 is U-shaped in elevational view (FIGS. 4 and 5) and has a lowermost edge 19 (when the pitcher is upright as in the various figures) generally at the same elevation as distal parts of the sidewall edge 13. Away from the spout 16, the sidewall areas 11 are formed with two auxiliary, less prominent spouts 21. Preferably, where the edge 13, in plan view of the pitcher (FIG. 3), is generally circular, the auxiliary spouts 21 are situated at 90 degrees from the prominent spout 16 and 180 degrees from one another.

For decorative effect, the sidewall areas 11 can be formed with shallow vertical flutes 22. While not shown, the flutes can be omitted in the field below the prominent spout 16, which may be considered the front of the pitcher 10, to accept printed or otherwise formed indicia such as advertising including logos of a commercial establishment where the pitcher is used. Ideally, for molding purposes and conservation of material, the pitcher walls are made more or less of uniform thickness.

Diametrally opposite and lying in the same imaginary vertical plane, indicated by the line 26, as the spout 16 is a handle 27. The handle 27, preferably, is molded so that it is integral and, therefore, fixed to the sidewall areas 11 at its upper and lower ends 28, 29, respectively. The handle 27 is of the standoff type such that its mid-length can be completely surrounded through 360 degrees by a person's fingers, including a thumb, to obtain a firm grasp of the pitcher.

A pair of opposed cooperating finger grips 31 are formed on the front of the sidewall areas 11 in locations straddling the zone under the prominent spout 16. The finger grips 32 are symmetrical with respect to the imaginary vertical plane represented by the line 26.

The finger grips 31 are in the form of recesses or insets in the sidewall areas 11, being substantially longer in the vertical (axial with respect to the generally cylindrical sidewall areas) than in their horizontal dimensions (radial and chordal with respect to the imaginary central axis of the sidewall areas). The grips are relatively long in the vertical direction, being ideally greater than one-half the height of the pitcher so that they can readily accommodate four fingers of the hand of a large adult. At their upper ends, the grips terminate relatively abruptly at sidewall surfaces that extend in generally radial planes indicated locally at 33.

FIG. 7 is a cross-sectional view taken in a horizontal plane indicated at 7-7 in FIG. 4. As illustrated in FIG. 7, the grips or recesses 31 are re-entrant on their vertical edges 34 closest to the opposed grip or recess. The re-entrant character where the effective width of the recess is reduced from that of an inner area 36 significantly reduces the tendency of a person's fingers to slip from the grips 31 even when the outer surfaces of the pitcher are wet. The radial or near radial upper ends 33 of the grips or recesses 31 are effective stops that prevent the pitcher from slipping down and out of a person's fingers. The various views of the figures are drawn essentially to scale for the embodiment illustrated. The distance between oppositely facing inner vertical surfaces 36 of the grips 31 is about 2½ inches, providing a comfortable, secure finger grip for an adult of average size.

The disclosed pitcher 10 has a high degree of utility, versatility, and convenience. Beverages iced with chips or cubes can be dispensed without ice by holding the handle 27 and pouring through the prominent spout 16 which by virtue of its narrow character and the adjacent higher proximal parts 17 restricts escape of ice chips and cubes. Ice elements can be dispensed with the liquid contents out of either of the side spouts 21, for example, regardless of whether the server is right or left handed. The server can hold the pitcher when dispensing from an auxiliary spout 21 by holding the pitcher with the handle 27 or finger grips 31. Further, the auxiliary or side spouts 21 can be used for speed pouring the contents by a skilled server.

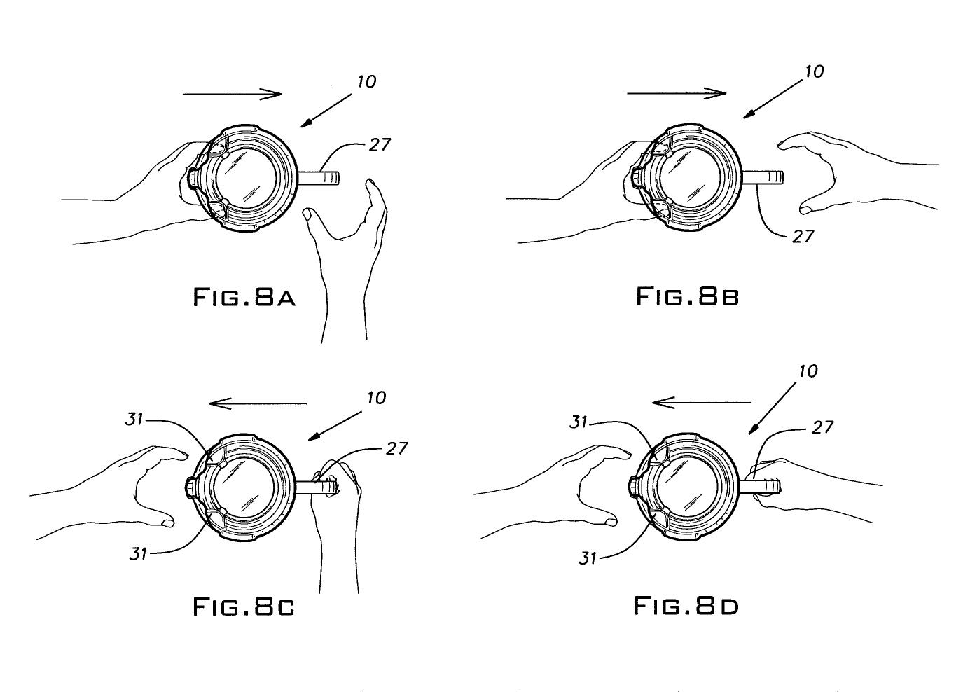

FIGS. 8A to 8D illustrate some of the ways that the pitcher 10 can be passed between the hands of different people or the same person. It will be seen or understood that the pitcher can be passed between persons standing at different orientations such as face-to-face or one to the side of the other. This feature can be especially useful in a crowded tavern or other facility where it is difficult to reach a person receiving the pitcher. A server passing the pitcher 10 to a customer or guest, for example, can demonstrate politeness and courtesy by using the finger grips 31 to hand the pitcher with the handle 27 towards the receiving party.

It should be evident that this disclosure is by way of example and that various changes may be made by adding, modifying or eliminating details without departing from the fair scope of the teaching contained in this disclosure. The invention is therefore not limited to particular details of this disclosure except to the extent that the following claims are necessarily so limited.

What is claimed is:

1. A pitcher for holding, carrying, and dispensing beverages comprising an open top vessel having a capacity adequate to fill several drinking glasses, the vessel having rigid sidewall areas extending upwardly from a rigid base area, the sidewall and base areas cooperating to form a boundary for the interior of the vessel, the sidewall areas encircling an open top through which a beverage is supplied into and dispensed out of the vessel, a standoff handle fixed to a sidewall area and adapted to be clasped through 360 degrees by the fingers and thumb of a person for presenting the vessel for filling with a beverage, carrying the vessel and dispensing beverage from the vessel, a spout projecting from surrounding sidewall areas on a side of the vessel opposite the handle, a pair of finger grips formed into the sidewall areas of the vessel on opposite sides of an imaginary plane passing through a center of the spout, the finger grips each having generally vertical surfaces facing away from a corresponding area of the other.

2. A pitcher as set forth in claim 1, including at least one secondary spout adjacent a sidewall area at said open top generally midway along the open top between a first zone where said imaginary plane intersects the open top in an area of the spout, and a second zone where said imaginary plane intersects said open top in an area adjacent the handle.

3. A pitcher as set forth in claim 1, wherein said finger grips each have a re-entrant portion where they merge with the sidewall areas proper, said re-entrant portions diverging from one another with reference to a direction outward from a central area of the interior of the vessel.

4. A spout as set forth in claim 3, wherein said finger grips are generally vertically disposed and said sidewall areas extend generally horizontally over said finger grips so that a person's fingers including a thumb gripping the pitcher at said grips will abut an adjacent part of the sidewall area extending over said finger grips so as to effectively prevent said pitcher from unintentionally sliding vertically downwardly in a person's fingers as they engage said grips.

5. A spout as set forth in claim 1, wherein said finger grips are generally vertically disposed and said sidewall areas extend generally horizontally over said finger grips so that a person's fingers including a thumb gripping the pitcher at said grips will abut an adjacent part of the sidewall area extending over said finger grips so as to effectively prevent said pitcher from unintentionally sliding vertically downwardly in a person's fingers as they engage said grips.

6. A pitcher as set forth in claim 1, wherein said finger grips extend upwardly along said sidewall areas from points adjacent said base area to points above a mid-height of said vessel.

7. A pitcher as set forth in claim 1, including a pair of oppositely disposed auxiliary spouts, each situated generally midway at said open top between said projecting spout and said handle.
